(19) United States
(12) Patent Application Publication
(10) Pub. No.: US 2005/0197834 A1
(43) Pub. Date: Sep. 8, 2005

(54) SYSTEMS, METHODS, AND AN ARTICLE OF MANUFACTURE FOR DETERMINING FREQUENCY VALUES ASSOCIATED WITH FORCES APPLIED TO A DEVICE

(75) Inventor: Charles T. Hatch, Gardnerville, NV (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 10/708,434

(22) Filed: Mar. 3, 2004

(51) Int. Cl. G10L 11/04

(52) U.S. Cl. 704/225

(57) ABSTRACT

A system, method, and article of manufacture for determining frequency values associated with forces applied to a device are provided. The method includes determining a first plurality of spectral amplitude values associated with a first forcing waveform applied to the device. The method further includes determining a second plurality of spectral amplitude values associated with a second forcing waveform applied to the device. The method further includes determining a maximum spectral amplitude value based on the first and second plurality of spectral amplitude values. The method further includes determining a threshold amplitude value based on the maximum spectral amplitude value and an acceptance value. The method further includes determining a first plurality of desired frequency values by selecting frequency values associated with a subset of the first plurality of spectral amplitude values that are greater than or equal to the threshold amplitude value. Finally, the method includes determining a second plurality of desired frequency values by selecting frequency values associated with a subset of the second plurality of spectral amplitude values that are greater than or equal to the threshold amplitude value.

### BACKGROUND OF INVENTION

Mechanical systems or devices can be modeled mathematically using dynamic models. The dynamic models generally utilize a forcing waveform as an input for the model. The forcing waveform is transferred mathematically using a Fourier transform from the time domain to the frequency domain. In the frequency domain, the forcing waveform is represented by a frequency domain spectrum corresponding to a plurality of spectrum lines each having a particular amplitude and frequency. Generally, the frequency domain spectrum is utilized as an input to the dynamic model to compute a desired output waveform. Computing the desired output waveform is also called solving the dynamic model. The computational time in a computer, however, is relatively high when computing the desired output waveform using an entire frequency domain spectrum of the forcing waveform.

Accordingly, it would be desirable to have a method for selecting a subset of the frequency values of the frequency domain spectrum associated with a forcing waveform in order to reduce the amount of computational time required to solve a dynamic model.

### SUMMARY OF INVENTION

A method for determining frequency values associated with forces applied to a device in accordance with an exemplary embodiment is provided. The method includes determining a first plurality of spectral amplitude values associated with a first forcing waveform applied to the device. The method further includes determining a second plurality of spectral amplitude values associated with a second forcing waveform applied to the device. The method further includes determining a maximum spectral amplitude value based on the first and second plurality of spectral amplitude values. The method further includes determining a threshold amplitude value based on the maximum spectral amplitude value and an acceptance value. The method further includes determining a first plurality of desired frequency values by selecting frequency values associated with a subset of the first plurality of spectral amplitude values that are greater than or equal to the threshold amplitude value. Finally, the method includes determining a second plurality of desired frequency values by selecting frequency values associated with a subset of the second plurality of spectral amplitude values that are greater than or equal to the threshold amplitude value.

An article of manufacture in accordance with an exemplary embodiment is provided. The article of manufacture includes a computer storage medium having a computer program encoded therein for determining frequency values associated with forces applied to a device. The computer storage medium includes code for determining a first plurality of spectral amplitude values associated with a first forcing waveform applied to the device. The computer storage medium further includes code for determining a second plurality of spectral amplitude values associated with a second forcing waveform applied to the device. The computer storage medium further includes code for determining a maximum spectral amplitude value based on the first and second plurality of spectral amplitude values. The computer storage medium further includes code for determining a threshold amplitude value based on the maximum spectral amplitude value and an acceptance value. The computer storage medium further includes code for determining a first plurality of desired frequency values by selecting frequency values associated with a subset of the first plurality of spectral amplitude values that are greater than or equal to the threshold amplitude value. Finally, the computer storage medium includes code for determining a second plurality of desired frequency values by selecting frequency values associated with a subset of the second plurality of spectral amplitude values that are greater than or equal to the threshold amplitude value.

A system for determining frequency values associated with forces applied to a device in accordance with another exemplary embodiment is provided. The system includes a first sensor operably coupled to the device. The first sensor generates a first signal over time indicative of a first forcing waveform applied to the device. The system further includes a second sensor operably coupled to the device. The second sensor generates a second signal over time indicative of a second forcing waveform applied to the device. The system further includes a computer operably communicating with the first and second sensors. The computer is configured to determine a first plurality of spectral amplitude values associated with the first forcing waveform. The computer is further configured to determine a second plurality of spectral amplitude values associated with the second forcing waveform. The computer is further configured to determine a maximum spectral amplitude value based on the first and second plurality of spectral amplitude values. The computer is further configured to determine a threshold amplitude value based on the maximum spectral amplitude value and an acceptance value. The computer is further configured to determine a first plurality of desired frequency values by selecting frequency values associated with a subset of the first plurality of spectral amplitude values that are greater than or equal to the threshold amplitude value. The computer is further configured to determine a second plurality of desired frequency values by selecting frequency values associated with a subset of the second plurality of spectral amplitude values that are greater than or equal to the threshold amplitude value.

A system for determining frequency values associated with forces applied to a device in accordance with another exemplary embodiment is provided. The system includes a first sensor means operably coupled to the device for generating a first signal over time indicative of a first forcing waveform applied to the device. The system further includes a second sensor means operably coupled to the device for generating a second signal over time indicative of a second forcing waveform applied to the device. The system further includes a computer means for operably communicating with the first and second sensors. The computer means is configured to determine a first plurality of spectral amplitude values associated with the first forcing waveform. The computer means is further configured to determine a second plurality of spectral amplitude values associated with the second forcing waveform. The computer means is further configured to determine a maximum spectral amplitude value based on the first and second plurality of spectral amplitude values. The computer means is further configured to determine a threshold amplitude value based on the maximum spectral amplitude value and an acceptance value. The computer means is further configured to determine a first plurality of desired frequency values by selecting frequency values associated with a subset of the first plurality of spectral amplitude values that are greater than or equal to the threshold amplitude value. The computer means is further configured to determine a second plurality of desired frequency values by selecting frequency values associated with a subset of the second plurality of spectral amplitude values that are greater than or equal to the threshold amplitude value.

Other systems and/or methods according to the embodiments will become or are apparent to one with skill in the art upon review of the following drawings and detailed description. It is intended that all such additional systems and methods be within the scope of the present invention, and be protected by the accompanying claims.

### BRIEF DESCRIPTION OF DRAWINGS

FIG. 1 illustrates a compressor monitoring system including a compressor and a monitoring computer.

FIG. 2 is a schematic of a portion of a crankshaft of the compressor of FIG. 1.

FIGS. 3-8 are flowcharts of a method for determining frequency values associated with forces applied to the compressor crankshaft.

FIG. 9 is a simplified schematic of the crankshaft, the connecting rod, the piston rod, and the piston—of the compressor illustrated in FIG. 1.

### DETAILED DESCRIPTION

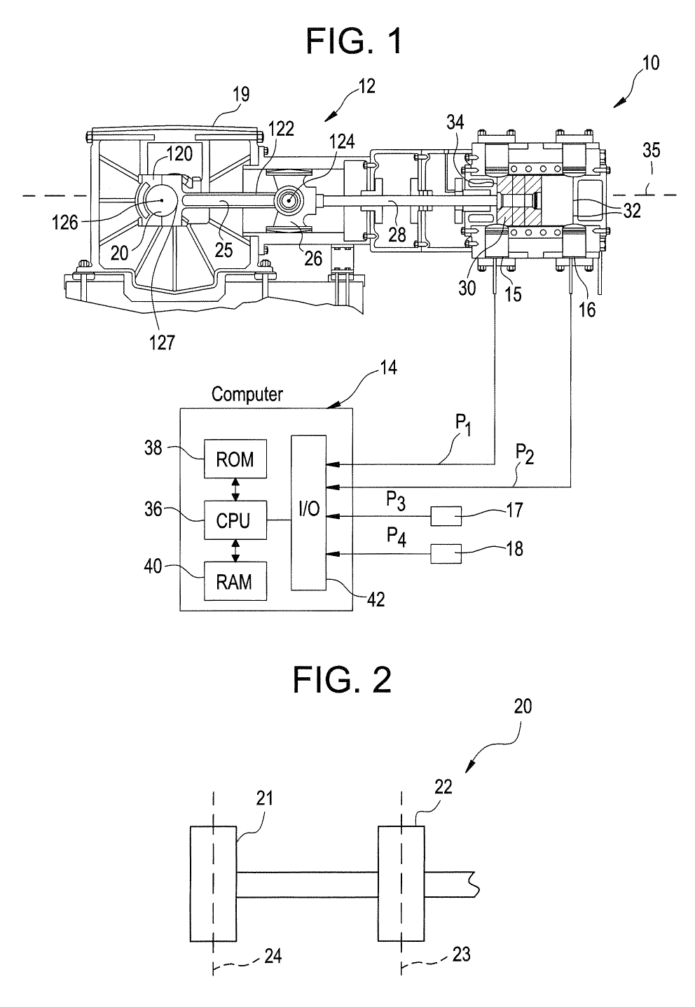

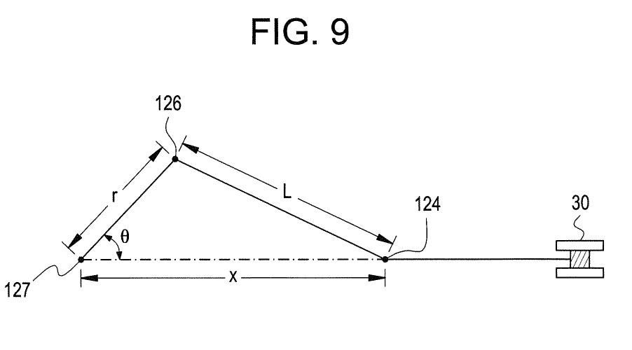

Referring to FIGS. 1, 2 and 9, a compressor monitoring system 10 is illustrated for monitoring the operation of a compressor 12. The compressor monitoring system 10 further includes pressure sensors 15, 16, 17, 18 and a monitoring computer 14. The configuration of the compressor monitoring system 10 will be briefly explained in order to better understand a method for determining frequency values associated with forces applied to a crankshaft of the compressor 12.

The compressor 12 is provided to force a fluid through a head-end chamber 32 and a crank end chamber 34. As shown, compressor 12 includes a housing 19, a crankshaft 20, a connecting rod 25, a cross-head 26, a cross-head pin 124, a piston rod 28, and a piston 30. It should be noted that although only one piston is shown for simplicity of understanding, compressor 12 can include a plurality of pistons, connecting rods, cross-head pins, and piston rods.

The housing is provided to enclose all of the remaining elements of the compressor 12. The crankshaft 20 is disposed in the housing 19 and is operably coupled to an actuating means (not shown) that rotates crankshaft 20. The crankshaft 20 has a first crankshaft throw 21, adjacent a large end 120 of connecting rod 25. Further, the crankshaft 20 is operably coupled to the large end 120 of connecting rod 25. Further, the cross-head 26 is operably coupled at the cross-head pin 124 to a small end 122 of connecting rod 25.

It should be noted that crankshaft 20 further includes a crankshaft throw 22 torsionally coupled adjacent another connecting rod (not shown).

As shown, a second end of the cross-head 26 is coupled to the piston rod 28 which is linearly driven along an axis 35 by the cross-head 26. The piston rod 28 is further coupled to the piston 30. Thus, linear movement of the piston rod 28 linearly moves the piston 30 into either head-end chamber 32 or crank-end chamber 34, depending upon the direction of movement of the piston 30.

The pressure sensors 15, 16 are provided to generate pressure signals (P1) and (P2) respectively, indicative of the pressure generated by piston 30 in the crank-end chamber 34 and the head-end chamber 32 respectively. As will be explained in greater detail below, signals (P1) and (P2) will be utilized by computer 14 to determine a forcing waveform representing forces applied to a plane 24 of the crankshaft throw portion 21.

The pressure sensors 17, 18 are provided to generate pressure signals (P3) and (P4) respectively, indicative of the pressure generated by another piston (not shown) in a crank-end chamber and a head-end chamber. As will be explained in greater detail below, signals (P3) and (P4) will be utilized by computer 14 to determine a forcing waveform representing forces applied to a plane 23 of the crankshaft throw portion 22.

The monitoring computer 14 is provided to receive the pressure signals (P1), (P2), from pressure sensors 15, 16, respectively and to generate a first forcing waveform. The computer 14 is further provided to receive the pressure signals (P3), (P4) from the pressure sensors 17, 18 and to generate a second forcing waveform. After generating the first and second forcing waveforms, the computer 14 is provided to implement a method for determining frequency values associated with the first and second forcing waveforms 20. The monitoring computer 14 includes a CPU 36 that operably communicates with the storage media including read-only memory (ROM) 38 and a random access memory (RAM) 40. The storage media may be implemented using any of a number of known memory devices such as PROMs, EPROMs, EEPROMS, flash memory or any other electric, magnetic, optical or combination memory device capable of storing data, some of which represent executable instructions used by CPU 36. The CPU 36 communicates via the I/O interface 42 with pressure sensors 15, 16, 17, 18.

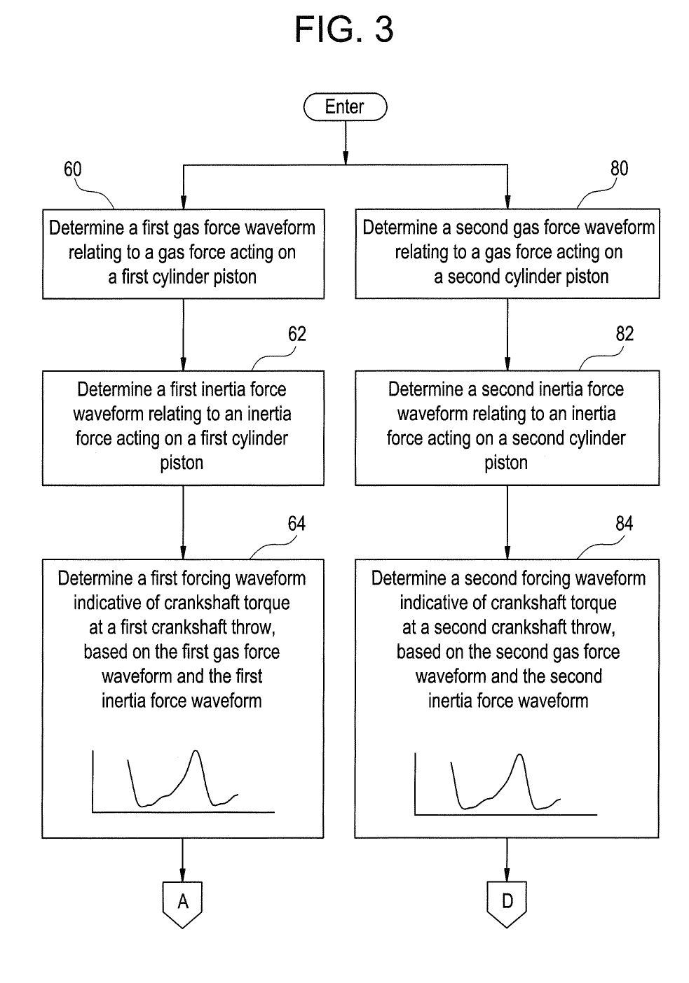

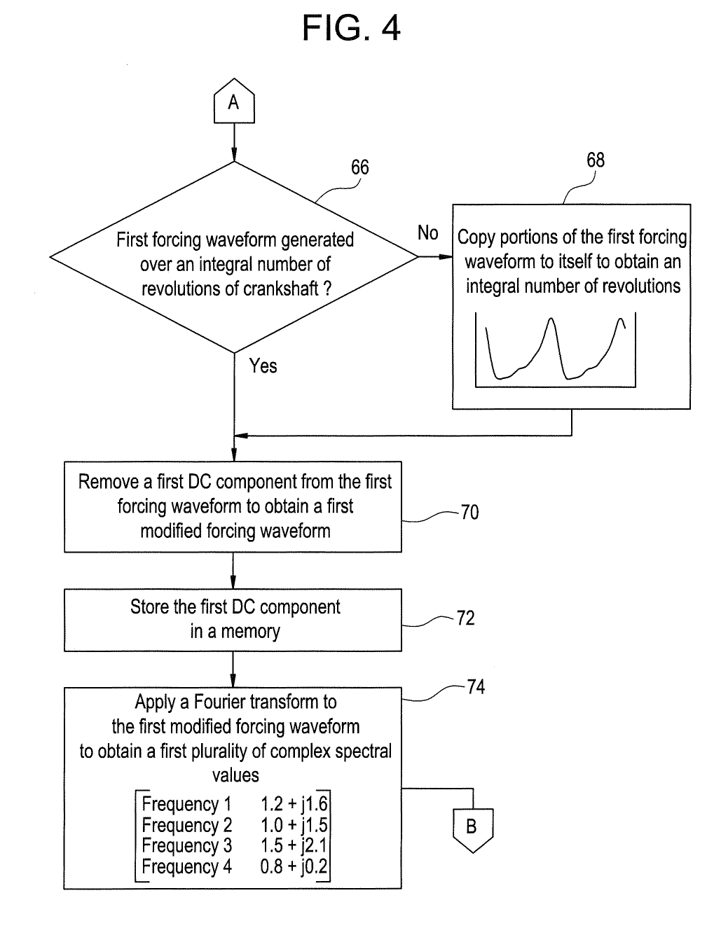

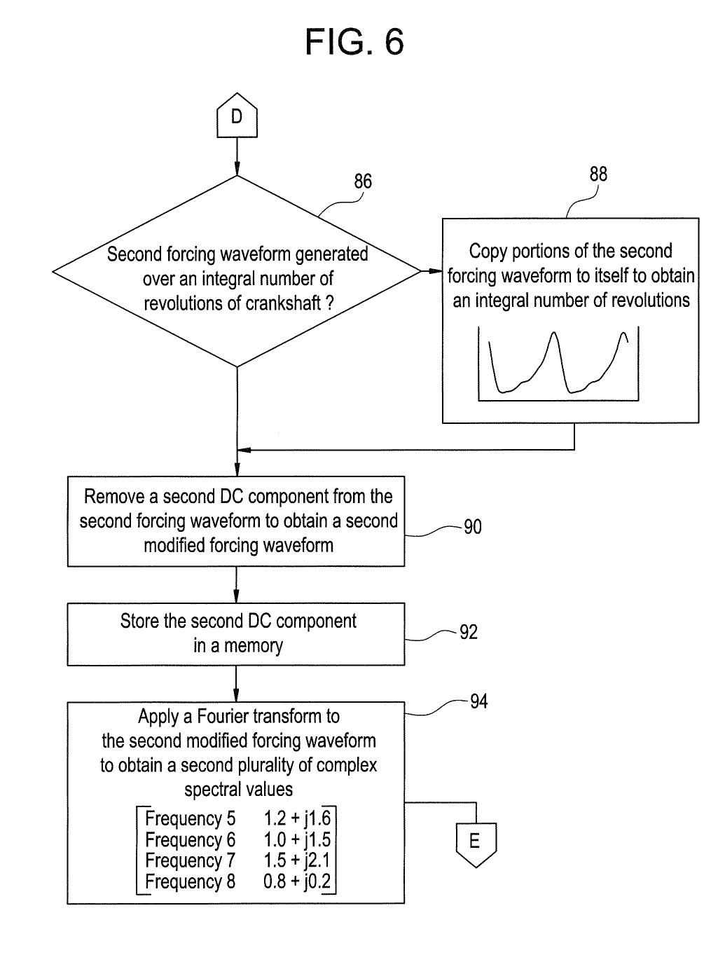

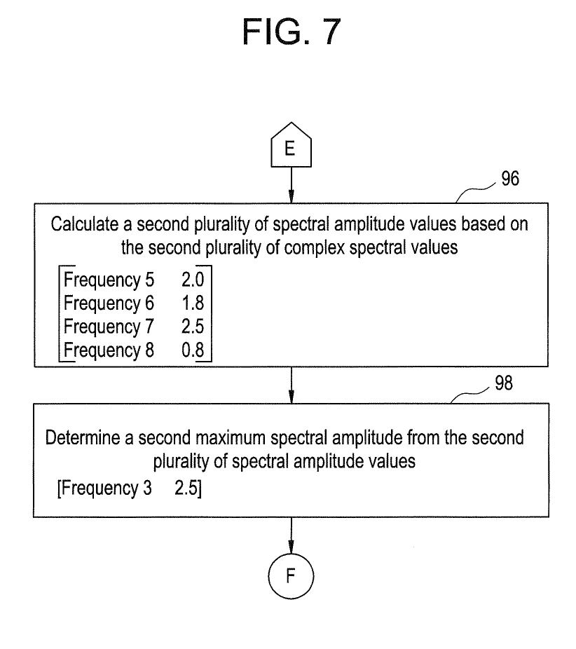

Referring to FIGS. 3-8, a method for determining frequency values associated with forces applied to the crankshaft 20 will now be explained. The method is directed to determining a first and second plurality of desired frequency values associated with first and second forcing waveforms, respectively, applied to the crankshaft throw portions 21, 22, respectively. It should be noted that additional forcing waveforms could be calculated for additional components associated with the crankshaft 20 including crankshaft throw portions, a flywheel, and a motor driving the crankshaft (not shown). Further, it should be noted that in the exemplary embodiment the CPU 36 can execute the steps 60-78 utilizing a first forcing waveform while concurrently executing steps 80-98 utilizing a second forcing waveform.

At step 60, the CPU 36 determines a first gas force waveform relating to a gas force acting on the first piston 30 based on the pressure signals (P1), (P2). The first gas force waveform can be determined by iteratively calculating the following equation over time:
F_{GAS1}=(P_{CE1}A_{CE1}−P_{HE1}A_{HE1}−P_{AMB1}A_{ROD1}
where
F_{GAS1} represents an instantaneous gas pressure;
P_{CE1} represents the pressure in the crank-end chamber obtained from the signal P1;
A_{CE1} represents the area of the crank-end chamber;
P_{HE1} represents the pressure in the head-end chamber obtained from the signal P2;
A_{HE1} represents the area of the head-end chamber
P_{AMB1} represents the pressure of gas in the housing pushing against the piston rod; and

A_{ROD1} represents the area of the piston rod.

At step 62, the CPU 36 determines a first inertia force waveform relating to an inertia force of the first cylinder piston 30. The first inertia force waveform can be determined by iteratively calculating the following equation over time:
Fₘ₁=(m_{xhead1}+mₚ₁+m_{prod1}+m_{consm1})\ddot{x}1
where

Fₘ₁ represents an instantaneous inertia force of the cross-head pin, the piston, the piston rod, and the connecting rod small end;
m_{xhead1} represents the mass of the cross-head pin;
mₚ₁ represents the mass of the piston;
m_{prod1} represents the mass of the piston rod; and,
m_{consm1} represents the mass of the connecting rod small end
\ddot{x}
1 represents the acceleration of the cumulative masses illustrated in the equation.

At step 64, the CPU 36 determines a first forcing waveform indicative of a crankshaft torque at the crankshaft throw 21. The first forcing waveform is determined based on the first gas force waveform and the first inertia force waveform. The first forcing waveform can be determined by iteratively calculating the following equation over time:

$$T1 = - ( {F}_{GAS 1} - {F}_{m 1} ) r sin θ [ 1 + \frac{r cos θ1}{\sqrt{{L}^{2} - {r}^{2} {sin}^{2} θ1}} ]$$

where
T1 represents an instantaneous torque at the crankshaft throw;
r represents the distance from a crankshaft rotation axis 127 to the crankshaft yoke centerpoint 126;
θ1 represents an angular position of the crankshaft; and,

L represents the length of the connecting rod between the crankshaft yoke centerpoint 126 and the centerpoint of the cross-head pin 124.

Next at step 66, the CPU 36 makes a determination as to whether the first forcing waveform was generated over an integral number of revolutions of the crankshaft. If the value of step 66 equals “yes”, the method advances to step 70. Otherwise the method advances to step 68.

At step 68, the CPU 36 copies portions of the first forcing waveform to itself to obtain a first forcing waveform having points relating to an integral number of revolutions of the crankshaft. After step 68, the method advances to step 70.

At step 70, the CPU 36 removes a first DC component from the first forcing waveform to obtain a first modified forcing waveform.

At step 72, CPU 36 stores the first DC component in ROM 38.

At step 74, the CPU 36 applies a Fourier transform to the first modified forcing waveform to obtain a first plurality of complex spectral values. For example, the first plurality of complex spectral values could have the following values: (i) 1.2+j1.6, (ii) 1.0+j1.5, (iii) 1.5+j2.1, (iv) 0.8+j0.2.

Next at step 76, the CPU 36 calculates a first plurality of spectral amplitude values based on the first plurality of complex spectral values. Each of the first plurality of spectral amplitude values can be calculated using the following equation:
Amp1=\sqrt{Re²+Im²}
where
Amp1 represents the spectral amplitude;
Re²
represents the square of the real portion of the complex number;
Im²
represents the square of the imaginary portion of the complex number.

For example, the first plurality spectral amplitude values could have the values: (i) 2.0, (ii) 1.8, (iii) 2.6, (iv) 0.8—based on the first plurality of complex spectral values of: (i) 1.2+j1.6, (ii) 1.0+j1.5, (iii) 1.5+j2.1, (iv) 0.8+j0.2, respectively.

At step 78, the CPU 36 determines a first maximum spectral amplitude from the first plurality of spectral amplitude values. In particular, the CPU 36 determines which one of the first plurality of spectral amplitude values has the greatest numerical value.

Referring to FIGS. 1, 3, 6, and 7, the steps 80-98 generate a second forcing waveform associated with a second piston (not shown) that will now be explained. For purposes of discussion, the second piston has an associated crank-end chamber, head-end chamber, piston, cross-head pin, and connecting rod.

At step 80, the CPU 36 determines a second gas force waveform relating to a gas force acting on a second piston (not shown) based on the pressure signals (P3), (P4). It should be noted that the sampling start time of pressure signals (P3) and (P4) is identical to the sampling start time of pressure signals (P1) and (P2). Further, the sampling rate of pressure signals (P3) and (P4) is identical to the sampling rate of pressure signals (P1) and (P2). The second gas force waveform can be determined by iteratively calculating the following equation over time:
F_{GAS2}=(P_{CE2}A_{CE2}−P_{HE2}A_{HE2})−P_{AMB2}A_{ROD2}
where
F_{GAS2} represents an instantaneous gas pressure;
P_{CE2} represents the pressure in the crank-end chamber obtained from the signal P3;
A_{CE2} represents the area of the crank-end chamber;
P_{HE2} represents the pressure in the head-end chamber obtained from the signal P4;
A_{HE2} represents the area of the head-end chamber;
P_{AMB2} represents the pressure of gas in the housing pushing against the piston rod; and

A_{ROD2} represents the area of the piston rod.

At step 82, the CPU 36 determines a second inertia force waveform relating to an inertia force of the second cylinder piston (not shown). The second inertia force waveform can be determined by iteratively calculating the following equation over time:
Fₘ₂=(m_{xhead2}+mₚ₂+m_{prod2}+M_{consm2})\ddot{x}2
where
Fₘ₂ represents an instantaneous inertia force of the cross-head pin, the piston, the piston rod, and the connecting rod small end;
m_{xhead2} represents the mass of the cross-head pin;
mₚ₂ represents the mass of the piston;
m_{prod2} represents the mass of the piston rod; and,
m_{consm2} represents the mass of the connecting rod small end
\ddot{x}
2 represents the acceleration of the cumulative masses illustrated in the forgoing equation.

At step 84, the CPU 36 determines a second forcing waveform indicative of a crankshaft torque at the crankshaft throw 22. The second forcing waveform is determined based on the second gas force waveform and the second inertia force waveform. The second forcing waveform can be determined by iteratively calculating the following equation over time:

$$T2 = - ( {F}_{GAS 2} + {F}_{m 2} ) r sin θ2 [ 1 + \frac{r cos θ2}{\sqrt{{L}^{2} - {r}^{2} {sin}^{2} θ2}} ]$$

where
T2 represents an instantaneous torque at the crankshaft throw;
r represents the distance from a crankshaft rotation axis 127 to the crankshaft yoke centerpoint;
θ2 represents an angular position of the crankshaft;
L represents the length of the connecting rod between the crankshaft yoke centerpoint and the centerpoint of the cross-head pin.

Next at step 86, the CPU 36 makes a determination as to whether the second forcing waveform was generated over an integral number of revolutions of the crankshaft. If the value of step 86 equals “yes”, the method advances to step 90. Otherwise, the method advances to step 88.

At step 88, the CPU 36 copies portions of the second forcing waveform to itself to obtain a second forcing waveform having points relating to an integral number of revolutions of the crankshaft. After step 88, the method advances to step 90.

At step 90, the CPU 36 removes a second DC component from the second forcing waveform to obtain a second modified forcing waveform.

At step 92, CPU 36 stores the second DC component in ROM 38.

At step 94, the CPU 36 applies a Fourier transform to the second modified forcing waveform to obtain a second plurality of complex spectral values. For example, the second plurality of complex spectral values could have the following values: (i) 1.2+j1.6, (ii) 1.0+j1.5, (iii) 1.5+j2.1, (iv) 0.8+j0.2.

Next to step 96, the CPU 36 calculates a second plurality of spectral amplitude values based on the second plurality of complex spectral values. Each of the second plurality of spectral amplitude values can be calculated using the following equation:
Amp2=\sqrt{Re²+Im²}
where
Amp2 represents a spectral amplitude;
Re²
represents the square of the real portion of the complex number;
Im²
represents the square of the imaginary portion of the complex number.

For example, the second plurality spectral amplitude values could have the values: (i) 2.0, (ii) 1.8, (iii) 2.6, (iv) 0.8 —based on the second plurality of complex spectral values of: (i) 1.2+j1.6, (ii) 1.0+j1.5, (iii) 1.5+j2.1, (iv) 0.8+j0.2, respectively.

At step 98, the CPU 36 determines a second maximum spectral amplitude from the second plurality of spectral amplitude values. In particular, the CPU 36 determines which one of the second plurality of spectral amplitude values has the greatest numerical value.

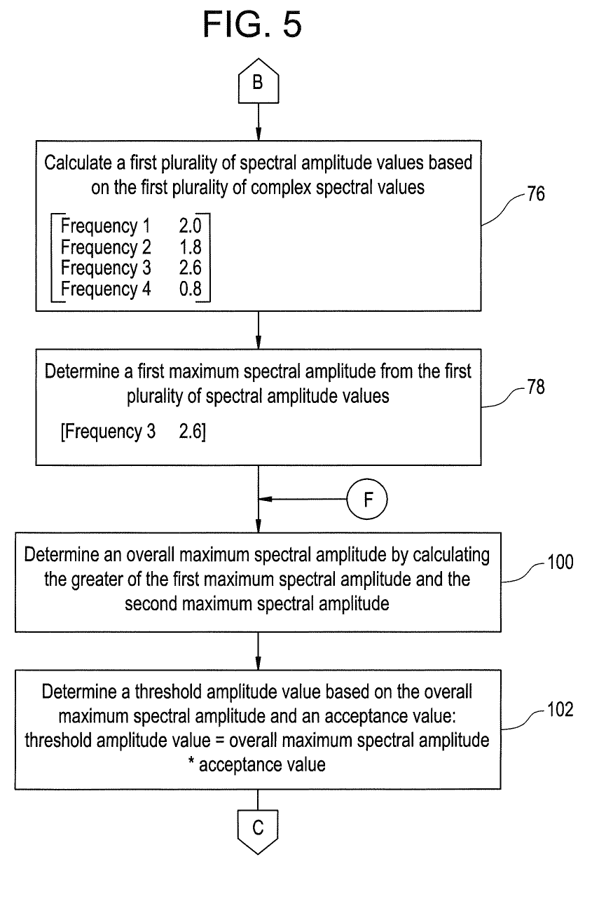

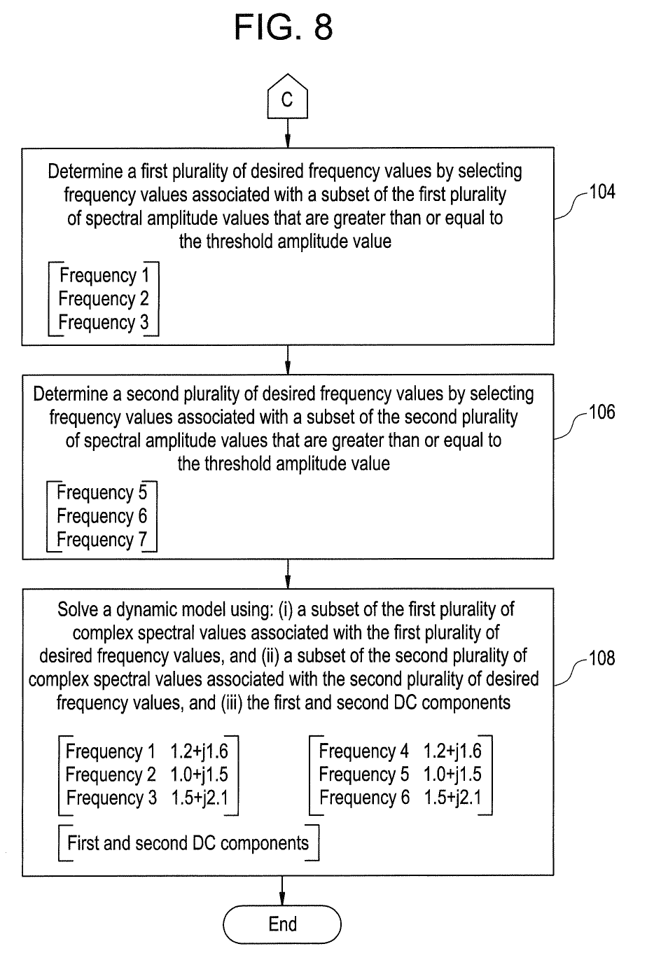

Referring to FIGS. 5 and 8, after either of steps 78 or 98, the method advances to step 100. At step 100, the CPU 36 determines an overall maximum spectral amplitude by calculating the greater of the first maximum spectral amplitude and the second maximum spectral amplitude.

Next to step 102, the CPU 36 determines a threshold amplitude value based on the overall maximum spectral amplitude and acceptance of value. For example, the threshold amplitude value can be calculated using the following equation:
threshold amplitude value=overall maximum spectral amplitude*acceptance value

The acceptance value can be empirically determined based upon the number of desired spectral amplitudes and the desired degree of accuracy in the solution of the dynamic model. For example, the overall maximum spectral amplitude could be 2.6 and the acceptance value could be about 0.4, resulting in a threshold amplitude value of 1.04. It should be noted that the desired degree of accuracy can be empirically determined by comparing the solution of the dynamic model using a specific acceptance value to a corresponding measured value.

Next at step 104, the CPU 36 determines a first plurality of desired frequency values by selecting frequency values associated with a subset of the first plurality of spectral amplitude values that are greater than or equal to the threshold amplitude value. For example, the first plurality of desired frequency values could include: frequency1, frequency2, and frequency3 because the spectral amplitude values associated with these frequencies are greater than the threshold amplitude value of 1.04.

Next at step 106, the CPU 36 determines a second plurality of desired frequency values by selecting frequency values associated with a subset of the second plurality of spectral amplitude values that are greater than or equal to the threshold amplitude value. For example, the second plurality of desired frequency values could include: frequency5, frequency6, and frequency7 because the spectral amplitude values associated with these frequencies are greater than the threshold amplitude value of 1.04.

Next at step 108, the CPU 36 solves a dynamic model of the crankshaft using a set of frequencies that comprise the union of: (i) the first and second DC components, (ii) a subset of the first plurality of complex spectral values associated with the first plurality of desired frequency values, and (iii) a subset of the second plurality of complex spectral values associated with the second plurality of desired frequency values.

The inventive method and article of manufacture for determining frequency values associated with forces applied to the crankshaft represents a substantial advantage over known methods. In particular, the embodiments of the invention provide a technical effect of selecting a subset of the frequency values of the frequency domain spectrum associated with one or more forcing waveforms in order to dramatically reduce the amount of computational time required to solve a dynamic model in a computer.

While the invention is described with reference to an exemplary embodiment, it will be understood by those skilled in the art that various changes may be made and equivalence may be substituted for elements thereof without departing from the scope of the invention. In addition, many modifications may be made to the teachings of the invention to adapt to a particular situation without departing from the scope thereof. Therefore, it is intended that the invention not be limited to the embodiment disclosed for carrying out this invention, but that the invention includes all embodiments falling with the scope of the intended claims. Moreover, the use of the term's first, second, etc. does not denote any order of importance, but rather the term's first, second, etc. are used to distinguish one element from another.

1. A method for determining frequency values associated with forces applied to a device, comprising:
determining a first plurality of spectral amplitude values associated with a first forcing waveform applied to the device;
determining a second plurality of spectral amplitude values associated with a second forcing waveform applied to the device;
determining a maximum spectral amplitude value based on the first and second plurality of spectral amplitude values;
determining a threshold amplitude value based on the maximum spectral amplitude value and an acceptance value;
determining a first plurality of desired frequency values by selecting frequency values associated with a subset of the first plurality of spectral amplitude values that are greater than or equal to the threshold amplitude value; and,
determining a second plurality of desired frequency values by selecting frequency values associated with a subset of the second plurality of spectral amplitude values that are greater than or equal to the threshold amplitude value.

2. The method of claim 1 wherein the step of determining the first plurality of spectral amplitude values includes:
determining a first forcing waveform indicative of a force applied to the device over an integral number of rotations of the device;
removing a DC component of the first forcing waveform to obtain a first modified forcing waveform; and,
calculating the first plurality of spectral amplitude values associated with the first modified forcing waveform.

3. The method of claim 2 wherein the step of calculating the first plurality of spectral amplitude values includes applying a Fourier transform on the first modified forcing waveform to obtain the first plurality of spectral amplitude values.

4. The method of claim 2 wherein the first forcing waveform is determined from data collected over an integral number of revolutions of the device.

5. The method of claim 1 wherein the step of determining the maximum spectral amplitude value includes:
determining a first maximum value by determining a highest value in the first plurality of spectral amplitude values;
determining a second maximum value by determining a highest value in the second plurality of spectral amplitude values; and,
selecting the greater value of the first maximum value and the second maximum value to obtain the maximum spectral amplitude value.

6. The method of claim 1 wherein the step of determining the threshold amplitude value includes multiplying the maximum spectral amplitude value by the acceptance value to obtain the threshold amplitude value.

7. An article of manufacture, comprising:
a computer storage medium having a computer program encoded therein for determining frequency values associated with forces applied to a device, the computer storage medium including
code for determining a first plurality of spectral amplitude values associated with a first forcing waveform applied to the device;
code for determining a second plurality of spectral amplitude values associated with a second forcing waveform applied to the device;
code for determining a maximum spectral amplitude value based on the first and second plurality of spectral amplitude values;
code for determining a threshold amplitude value based on the maximum spectral amplitude value and an acceptance value;
code for determining a first plurality of desired frequency values by selecting frequency values associated with a subset of the first plurality of spectral amplitude values that are greater than or equal to the threshold amplitude value; and,
code for determining a second plurality of desired frequency values by selecting frequency values associated with a subset of the second plurality of spectral amplitude values that are greater than or equal to the threshold amplitude value.

8. The article of manufacture of claim 7 wherein the code for determining the first plurality of spectral amplitude values includes:
code for determining a first forcing waveform indicative of a force applied to the device over an integral number of rotations of the device;
code for removing a DC component of the first forcing waveform to obtain a first modified forcing waveform; and,
code for calculating the first plurality of spectral amplitude values associated with the first modified forcing waveform.

9. The article of manufacture of claim 7 wherein the code for calculating the first plurality of spectral amplitude values includes:
code for applying a Fourier transform on the first modified forcing waveform to obtain the first plurality of spectral amplitude values.

10. The article of manufacture of claim 7 wherein the first forcing waveform is determined from data collected over an integral number of revolutions of the device.

11. The article of manufacture of claim 7 wherein the code for determining the maximum spectral amplitude value includes:
code for determining a first maximum value by determining a highest value in the first plurality of spectral amplitude values;
code for determining a second maximum value by determining a highest value in the second plurality of spectral amplitude values; and,
code for selecting the greater value of the first maximum value and the second maximum value to obtain the maximum spectral amplitude value.

12. The article of manufacture of claim 7 wherein the code for determining the threshold amplitude value includes code for multiplying the maximum spectral amplitude value by the acceptance value to obtain the threshold amplitude value.

13. A system for determining frequency values associated with forces applied to a device, comprising:
a first sensor operably coupled to the device, the first sensor generating a first signal over time indicative of a first forcing waveform applied to the device;
a second sensor operably coupled to the device, the second sensor generating a second signal over time indicative of a second forcing waveform applied to the device; and,
a computer operably communicating with the first and second sensors, the computer configured to determine a first plurality of spectral amplitude values associated with the first forcing waveform, the computer is further configured to determine a second plurality of spectral amplitude values associated with the second forcing waveform, the computer is further configured to determine a maximum spectral amplitude value based on the first and second plurality of spectral amplitude values, the computer is further configured to determine a threshold amplitude value based on the maximum spectral amplitude value and an acceptance value, the computer is further configured to determine a first plurality of desired frequency values by selecting frequency values associated with a subset of the first plurality of spectral amplitude values that are greater than or equal to the threshold amplitude value, the computer is further configured to determine a second plurality of desired frequency values by selecting frequency values associated with a subset of the second plurality of spectral amplitude values that are greater than or equal to the threshold amplitude value.

14. A system for determining frequency values associated with forces applied to a device, comprising:
a first sensor means operably coupled to the device for generating a first signal over time indicative of a first forcing waveform applied to the device;
a second sensor means operably coupled to the device for generating a second signal over time indicative of a second forcing waveform applied to the device; and,
a computer means for operably communicating with the first and second sensors, the computer means configured to determine a first plurality of spectral amplitude values associated with the first forcing waveform, the computer means is further configured to determine a second plurality of spectral amplitude values associated with the second forcing waveform, the computer means is further configured to determine a maximum spectral amplitude value based on the first and second plurality of spectral amplitude values, the computer means is further configured to determine a threshold amplitude value based on the maximum spectral amplitude value and an acceptance value, the computer means is further configured to determine a first plurality of desired frequency values by selecting frequency values associated with a subset of the first plurality of spectral amplitude values that are greater than or equal to the threshold amplitude value, the computer means is further configured to determine a second plurality of desired frequency values by selecting frequency values associated with a subset of the second plurality of spectral amplitude values that are greater than or equal to the threshold amplitude value.
